(19) United States
(12) Patent Application Publication
(10) Pub. No.: US 2024/0361197 A1
(43) Pub. Date: Oct. 31, 2024

(54) VACUUM GAUGE ASSEMBLY WITH ORIENTATION SENSOR

(71) Applicant: Edwards Limited, Burgess Hill (GB)

(72) Inventor: Matthew Gareth Key, Hampden Park (GB)

(21) Appl. No.: 18/291,163

(22) PCT Filed: Jul. 28, 2022
(86) PCT No.: PCT/GB2022/051990

§ 371 Date: Jan. 22, 2024

(30) Foreign Application Priority Data
Jul. 29, 2021 (GB) 2110887.3

(51) Int. Cl. G01L 21/12

(52) U.S. Cl. CPC G01L 21/12

(57) ABSTRACT

The present disclosure relates to a vacuum gauge assembly 100 for measuring gas pressure in a vacuum system. The assembly comprises a pressure sensor element 130, an orientation sensor 160 that can determine an orientation of the pressure sensing element 130, and a microcontroller 155 configured to determine a gas pressure using data received from both the pressure sensing element 130 and the orientation sensor 160. The present disclosure also relates to an associated method of correcting a gas pressure output value in a vacuum gauge assembly 100.

This application is a national stage entry under 35 U.S.C. § 371 of International Application No. PCT/GB2022/051990, filed Jul. 28, 2022 and entitled “VACUUM GAUGE ASSEMBLY WITH ORIENTATION SENSOR,” which claims the benefit of GB Application No. 2110887.3, filed Jul. 29, 2021 and entitled “VACUUM GAUGE ASSEMBLY WITH ORIENTATION SENSOR,” the entire contents of each of which are incorporated herein by reference.

### TECHNICAL FIELD

This disclosure relates to a vacuum gauge assembly. This disclosure also relates to a vacuum gauge including the assembly and a method of correcting a gas pressure output value in the assembly.

### BACKGROUND

Vacuum gauges are commonly used to measure the pressure in a vacuum system. The pressure measurement can be used to check that the system has a vacuum of sufficiently low pressure for its intended purpose. If the measurement indicates that the pressure of the vacuum in the system is insufficiently low this can be used to indicate and detect a leak or defect in the system and/or provide feedback to aid control of a vacuum pump evacuating the system.

### SUMMARY OF THE INVENTION

From one aspect, the present disclosure provides a vacuum gauge assembly in accordance with claim 1.

It has been found that the pressure output accuracy for a vacuum gauge assembly can be adversely effected by the orientation of the pressure sensing element. By detecting the orientation of the pressure sensing element using the orientation sensor and using this data when measuring gas pressure, it is possible to more accurately determine the true gas pressure in the vacuum gauge assembly.

In an example of the above aspect, the microcontroller is configured to use data received from the orientation sensor to determine a correction to be applied to the data received from the pressure sensing element, and apply the correction to the data received from the pressure sensing element to determine the gas pressure.

This allows the gas pressure values output by the vacuum gauge assembly to be corrected according to whether a particular orientation is detected or not. In one example, the correction takes the form of a correction factor that is applied to the pressure output values.

In a further example of either of the above, the microcontroller is configured to normalise the data received from the pressure sensing element and apply the correction in the form of a correction factor to the normalised data.

In a further example of the above, the microcontroller comprises a memory and a processor in electrical communication therewith. The memory stores a lookup table of reference data and the correction factor, and instructs the processor to normalise the data received from the pressure sensing element before applying a transfer function and the correction factor thereto.

The normalisation of the data allows modification of the output pressure values of the gauge assembly to be more accurate and account of minor variations in the same gauge assembly design (e.g., due to incidental manufacturing/compositional differences, contamination and external environment differences). Applying the correction factor to the normalised data helps improve gauge accuracy, as it reduces the impact of adverse orientation effects on the normalised output data for the gauge.

In a further example of any of the above, the orientation sensor is configured to determine if the pressure sensing element is in one of a first orientation or a second orientation. The microcontroller stores a correction factor according to the second orientation and is configured to selectively apply the correction factor according to whether the first or second orientation is determined by the orientation sensor. In one example, the first orientation corresponds to a vertical orientation of the pressure sensing element, and the second orientation corresponds to a horizontal orientation of the pressure sensing element. In an alternative example, the first orientation corresponds to a horizontal orientation of the pressure sensing element, and the second orientation corresponds to a vertical orientation of the pressure sensing element.

This allows the correction factor to be applied accordingly to a different orientation of the pressure sensing element being detected compared to that which is expected or for which the gauge was originally calibrated when it was produced.

In a further example of any of the above, the correction factor is an average of a plurality of correction factors determined for different orientations of the pressure sensing element. In one example, the different orientations may be different horizontal orientations.

This provides a relatively simple way of calculating and applying a correction factor that improves gauge output accuracy across multiple pressure sensing element orientations.

In an alternative example of any of the above, the orientation sensor is further configured to determine if the pressure sensing element is in one of a third or fourth orientation. The microcontroller stores a first, second and third correction factor according to the second, third and fourth orientation, respectively, and is further configured to selectively apply the first, second or third correction factor according to the first, second, third or fourth orientation being determined by the orientation sensor, respectively. In one example, the first orientation is a vertical orientation of the pressure sensing element and the second, third and fourth orientations are different horizontal orientations of the pressure sensing element.

By storing and applying different correction factors for each different orientation when detected, a more complete treatment of gauge output errors from each orientation can be provided. This further improves the accuracy of the gauge assembly output data.

In a further example of any of the above, the pressure sensing element is a heater element for a Pirani vacuum gauge.

In another aspect, the present disclosure provides a vacuum gauge including the assembly of the above aspect or any of its examples.

In one example, the vacuum gauge is a Pirani vacuum gauge.

In another aspect, the present disclosure provides a method of correcting a gas pressure output value in a vacuum gauge assembly in accordance with claim 11.

By receiving and using orientation data when determining the gas pressure, a more accurate determination of the gas pressure can be made.

In one example of the above aspect, the method further comprises determining a correction to be applied to the data received from the pressure sensing element based on the data received from the orientation sensor, and applying the correction to the data received from the pressure sensing element in response to the data received from the orientation sensor.

In a further example of either of the above, the data received from the orientation sensor determines if the pressure sensing element is in one of a first orientation or a second orientation, and the method further comprises selectively applying the correction to the data received from the pressure sensing element based on whether the first or second orientation is determined by data from the orientation sensor.

These examples allow the gas pressure values output by the vacuum gauge assembly to be corrected according to whether a particular orientation is detected or not.

In a further example of any of the above, the method further comprises normalising the data received from the pressure sensing element and applying a transfer function thereto using a lookup table of reference data before applying the correction. The correction is then applied in the form of a correction factor to the normalised data.

Applying the correction factor to normalised data helps improve gauge accuracy, as it reduces the impact of adverse orientation effects on the normalised output data for the gauge.

In a further example of any of the above, the method is performed using a microcontroller.

The microcontroller includes a memory and a processor for storing the data and instructions for applying the correction and/or normalisation process to the gas pressure output data of the gauge assembly.

In examples, the above method utilises a vacuum gauge assembly including the features of the assembly of the above aspect or any of its examples.

Although certain advantages have been discussed in relation to certain features above, other advantages of certain features may become apparent to the skilled person following the present disclosure.

### BRIEF DESCRIPTION OF DRAWINGS

One or more non-limiting examples will now be described, by way of example only, and with reference to the accompanying figures.

FIG. 1 shows an exterior isometric view of a vacuum gauge assembly in accordance with an example of the present disclosure.

FIG. 2 shows a cross-section of the assembly of FIG. 1 viewed along line A-A.

FIG. 3A shows the pressure sensing element from the examples of FIGS. 1 and 2 in a vertical orientation.

FIG. 3B shows the pressure sensing element from the examples of FIGS. 1 and 2 in a first horizontal orientation.

FIG. 3C shows the pressure sensing element from the examples of FIGS. 1 and 2 in a second horizontal orientation.

FIG. 3D shows the pressure sensing element from the examples of FIGS. 1 and 2 in a third horizontal orientation.

FIG. 4 shows an example graph of raw input voltage and pressure output values for examples of the vacuum gauge having the pressure sensing element assembled in the different orientations according to FIGS. 3A-3D.

FIG. 5 shows an example graph of the raw data values from FIG. 4 being normalised according to a transfer function based on a lookup table of reference data at those data values.

FIG. 6 shows an example graph of the percentage errors in normalised pressure output values compared to true pressure values for examples of the vacuum gauge according to the orientations of FIGS. 3B-3D.

FIG. 7 shows an example graph of the correction factor calculated for examples of the vacuum gauge according to the orientations of FIGS. 3B-3D according to the percentage errors shown in FIG. 6, and further including a plot of an average correction factor.

FIG. 8 shows the effect on the percentage errors of gauge output data when the average correction factor from FIG. 7 is applied for normalised output data from a gauge having orientations B-D.

### DETAILED DESCRIPTION

Vacuum gauges typically use pressure sensing elements that can detect changes in the thermal or electric properties of the gas within the gauge and correlate this with the pressure of the gas.

One type of vacuum gauge used for this purpose is a thermal conductivity vacuum gauge.

Thermal conductivity vacuum gauges utilize the thermal conductivity of gases for the purpose of pressure measurements, and may also be known as heat-loss vacuum gauges. In general, these gauges utilise the relationship between the thermal conductivity of a gas and its pressure in order to arrive at a pressure measurement.

One such thermal conductivity vacuum gauge is a Pirani gauge.

In a Pirani gauge, the pressure sensing element is in the form of a heater element (usually a filament or wire) that is placed in contact with the working gas in the vacuum system and is connected into an electrical circuit that allows it to be heated using electrical energy. As gas molecules collide with the heater element they will transfer (i.e. conduct) heat away from it. If the gas is of a higher pressure, then there will be more molecules colliding with the heater element and so more heat will be transferred away from the heater element thereby (i.e. the gas has a higher thermal conductivity).

If the heater element is held at a constant current or voltage, then changes in the amount of heat transferred from the heater element due to changing gas pressure will cause its temperature (and thus resistance) to change a proportional amount. By measuring this change in resistance, the change in pressure of the gas can be measured. Alternatively, the heater element can be held at a constant temperature (and thus resistance), and the change in voltage needed to maintain this constant temperature depending on the gas pressure can be measured.

In this manner, the pressure of the gas is measured as a function of its thermal conductivity.

As will be appreciated by the skilled person, a common way to implement this in a Pirani gauge is to include the heater element as an arm in a Wheatstone bridge circuit.

The Pirani gauge is typically configured to operate between vacuum pressures (e.g., around 10⁻⁴ mbar to 10⁻³ mbar) and atmospheric pressure (e.g. around 10³ mbar). Unfortunately, at relatively higher gauge pressures e.g., between 100 mbar and atmospheric pressure, the accuracy of the gauge can be adversely influenced by convective effects. Specifically, the heater element can generate a convective current that causes the gas therein to heat up and rise within the gauge. This can cause cooler gas in the gauge to be drawn over the heater element, which will adversely affect its temperature/resistance or the amount of voltage required used to maintain it at a constant temperature.

Thus, this convective effect will create a deviation from the predicted gas pressure and thermal conductivity correlation for the gauge, and provide inconsistencies and errors in the pressure output from the gauge.

Moreover, the degree to which this convective effect influences the gauge is dependent on the orientation of the heater element within the gauge.

Although this description generally exemplifies a Pirani gauge assembly, it is to be understood that any other suitable type of thermal conductivity vacuum gauge assembly (where a heater element is used and a temperature compensation element is required may be used) may also benefit from this disclosure and are accordingly within the scope thereof. Such other thermal conductivity vacuum gauges may include, for example, a thermistor gauge assembly or a thermocouple gauge assembly.

Furthermore, other types of vacuum gauges, such as capacitance diaphragm vacuum gauges may also benefit from this disclosure.

In such gauges, the gas pressure is generally determined by measuring the relative capacitance in the gap between a plate and a moveable diaphragm (pressure sensing element).

The position of the diaphragm relative to the plate can be adversely by the orientation of the gauge. For example, the diaphragm may sag under the effects of gravity, which may move it towards or away from the plate to differing degrees, depending on its orientation. This can cause inaccuracies and errors in the measurement of the capacitance for a particular gas pressure, in the same way as the aforementioned convective effect in a thermal conductivity gauge. Accounting for the orientation of the pressure sensing element in vacuum gauges and provide appropriate correction to the gauge pressure output according thereto may be beneficial.

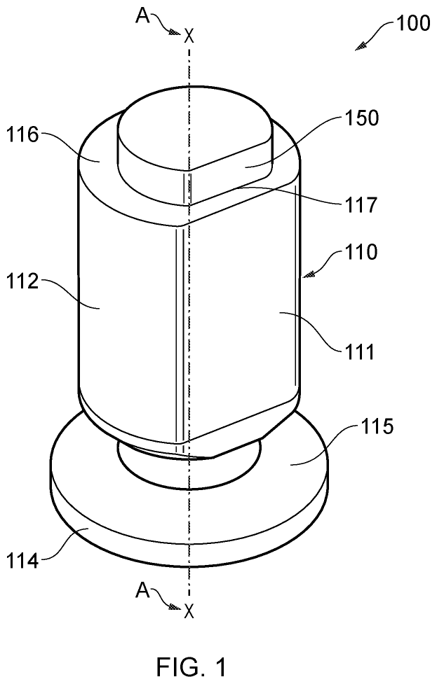

Referring to FIG. 1, a vacuum gauge assembly 100 is shown. The assembly 100 is a thermal conductivity vacuum gauge and includes a body 110 that has a sidewall 112 that extends axially along a longitudinal axis X between a base 114 and a top 116.

In the depicted example, the body 110 is generally annular, but with a chamfered section 111 around a portion of the circumference. As discussed below, this chamfered section 111 can aid attachment of the assembly with other component parts of a thermal conductivity vacuum gauge (e.g. a housing or covering (not shown)).

Although a specific shape of body 110 is depicted, it should be understood that within the scope of this disclosure any other suitable shape of body 110 can be used (e.g. square or rectangular cross-section).

The base 114 includes a flange 115 extending radially therefrom around longitudinal axis X). In one example, the flange 115 is of the NW25 specification, although any suitable size and shape of flange may be used within the scope of this disclosure.

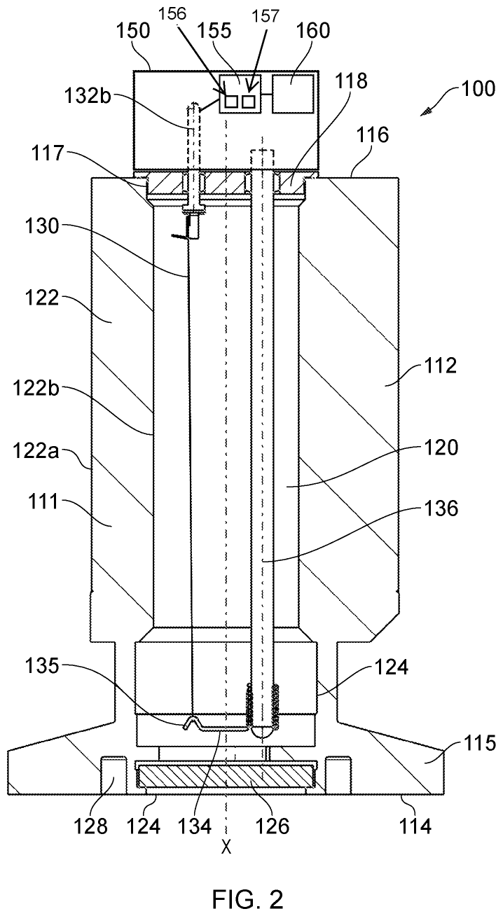

The top 116 includes an end cap 118 through which electrical connector 132 and support features 136 for a pressure sensing element 130 protrude (discussed below with reference to FIG. 2) and are secured therein.

The end cap 118 is fixed within an opening 117 defined in the top 116.

In some examples, the end cap 118 may be fixedly attached to the top 116, for example, by being welded into the opening 117, or by being press-fit therein. In other examples, the end cap 118 may be removably fixed into the top 116 by threaded engagement therewith. Such removable fixation methods may facilitate repair and replacement of the heater element 130 and connection and support features. In yet further examples, the end cap 118 may be omitted and the wall 122 of the body 110 extends radially across the top 116 without the opening 117 therein. In such examples, the connection and support features would extend through the wall 122 at the top 116 itself.

FIG. 2 shows a cross-section of assembly 100 taken along the longitudinal axis X (along the line defined by arrows A-A) and viewed in the direction of arrows A-A. FIG. 2 gives a view of the internal structure and components within the body 110, as discussed below.

The body 110 defines an internal chamber 120 which is configured to receive working or process gas (e.g. from a vacuum system) when the assembly 100 is in use.

By ‘working or process gas’, it is meant the gas (or gases) that the assembly intends to measure the pressure of. The ‘working gas’ is usually the gas (or gases) that are being “worked on” (i.e., being evacuated) by the vacuum system. The pressure of this gas can provide an indication of the general pressure of vacuum in the system.

In the depicted example, the body 110 is generally tubular, and may also be known as a ‘body tube’. The internal chamber 120 is accordingly generally cylindrical about the longitudinal axis X within the body 110.

The body 110 is defined or formed by a wall 122. The wall 122 is defined between an outer facing wall surface 122a and an opposing, inner facing wall surface 122b. Surfaces 122a and 122b are generally annular in accordance with the depicted shape of the body 110. The outer facing wall surface 122a is radially outward of the inner facing wall surface 122b and faces the exterior of the assembly 100. The inner facing wall surface 122b faces the interior of the assembly 100 and defines (or encloses) the internal chamber 120.

The body 110 could be made of any suitable material, such as a stainless steel or aluminium alloy, or plastic material (where operating conditions and temperature permit). The body 110 can also be made from any suitable manufacturing method, such as by being moulded/cast, machined from a solid block or 3D printed. The base 114 defines an inlet passage 124 for the chamber 120.

The inlet passage 124 extends axially from the base 114 and into the chamber 120. The inlet passage 124 is in fluid communication with the chamber 120, and permits working gas (e.g. from a vacuum system) to enter and exit the chamber 120 during use.

A filter element 126 is disposed across the inlet passage 124 for filtering the working gas before it enters the chamber 120. The filter element 126 passes radially across the inlet passage 124 relative to the longitudinal axis X. The filter element 126 is used to ensure contaminants do not enter the chamber 120. Such contaminants may damage the assembly 100 (e.g. by corroding or depositing on the heater element 130, wall surface 122b or electrical connections within the chamber 120) and/or may interfere with the pressure measurement process and provide inaccuracies therein. In one example, the filter element 126 is a stainless steel (e.g. 316L) 30-2 mesh, although any other suitable type (e.g. a membrane), material and specification of filter element 126 may be used within the scope of this disclosure.

The flange 115 of the base 114 includes a recess or groove 128 defined therein. The recess 128 is annular around the longitudinal axis X and permits an O-ring seal to be seated therein. This can allow a better seal to be formed between the assembly 100 and a vacuum system when in use, and secured in position at the base 114 via flange 115.

In the depicted example (which is a thermal conductivity gauge), the pressure sensing element 130 is a heater element 130 that is disposed within the chamber 120. In the depicted example, the heater element 130 extends generally axially into the chamber 120 from the top 116 towards the base 114.

The heater element 130 in the depicted example is a filament for heating by an electric power source. The filament may be made from any suitable material, such as Tungsten or Platinum. Platinum in particular, may be used in vacuum system environments or applications that are known to contain more corrosively aggressive agents and/or working gases.

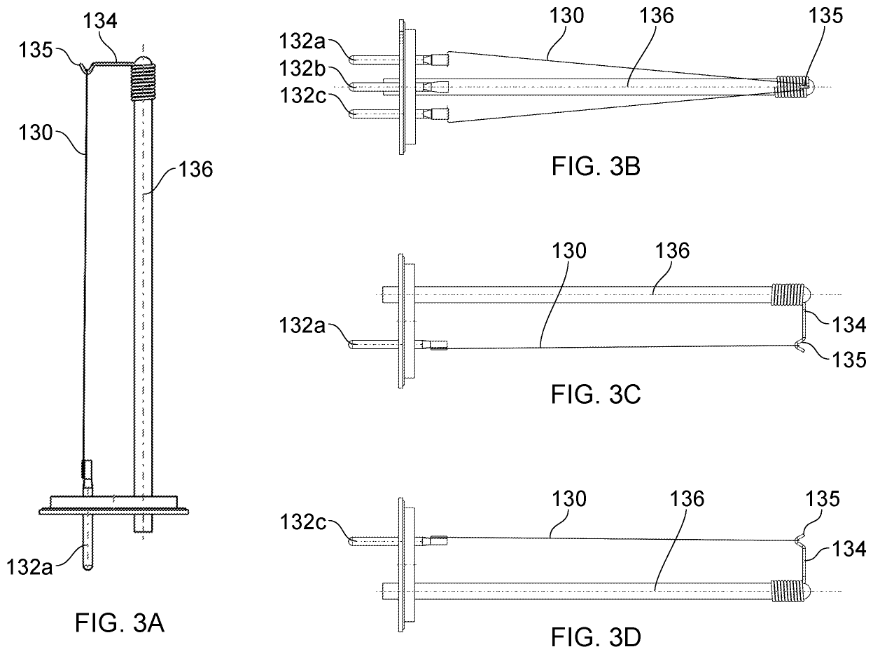

As also visible in FIGS. 3A-3D, electrical connectors or pins 132a, 132b, 132c protrude through the end cap 118 and are secured therein. The heater element 130 is connected to certain ones of the electrical connectors 132a, 132b, 132c to permit electrical communication therewith for control of the heater element 130.

In the depicted example, the connectors 132a, 132c are connected to two opposing ends of the heater assembly 130, whilst the connector 132b is used for grounding purposes.

The connectors 132a, 132b, 132c are subsequently connected to an electrical control circuit (not shown) in an electronics module 150 (discussed in more detail below) that can provide electrical power to heat and control the heater assembly 130 when the assembly 100 is in use.

The heater element 130 can be connected in any suitable manner to connectors 132a, 132c, e.g. by being wrapped around a base of the connectors or welded or soldered thereto etc.

The heater element 130 is supported within the chamber 120 by a support structure. In the depicted example, the support structure is in the form of a spring arm 134 and a bar 136.

The bar 136 protrudes through end cap 118 and is secured thereto. The bar 136 extends axially into the chamber 120 from the top 116 towards the base 114 substantially parallel to the heater element 130. In the depicted example, the bar 136 is a cylindrical rod.

The spring arm 134 is secured to the end of the bar 136 nearest the base 114, and extends radially (relative to the longitudinal axis X) to support the heater element 130.

The spring arm 134 features a hook 135 around which the heater element 130 is passed. The spring arm 134 and bar 136 are used to provide a tension that keep the heater element 130 taught and supported in use between the connectors 132a, 132c.

As will be appreciated, in the depicted example, the heater assembly 130 provides a substantially V-shape or U-shape when hung between the connectors 132a, 132c via the hook 135.

Although one particular arrangement of the heater element 130, electrical connectors 132a, 132b, 132c and support structure thereof is shown, it is to be understood that within the scope of this disclosure any other suitable arrangement may be used. For example, different numbers and types of electrical connectors 132a, 132b, 132c, a different type of heater element 130 (e.g. a thermistor), and different numbers or types of components to bar 136 and spring arm 134 may be used.

In the depicted example, the electronics module 150 is attached to the end cap 118 and receives the electrical connectors 132a, 132b, 132c and support features 136 of the pressure sensing element 130. The electronics module 150 can be attached to the end cap 118 in any suitable removable or non-removable manner, e.g., via fasteners, threaded engagement, or adhesive.

The electronics module 150 is depicted in a highly schematic form, and may have any suitable geometry and be mounted at any other suitable position on the gauge 100.

The electronics module 150 is a housing that contains a microcontroller 155 and other general electronic circuitry and computing elements (not shown) that are in electrical communication with the electrical connectors 132a, 132b, 132c, and which are configured to control heating of the pressure sensing element 130 and calculate the pressure output resulting therefrom.

The pressure sensing element 130 and electronics module 150 (including the microcontroller 155, associated circuitry and computing elements) can be powered in any suitable manner.

For example, they may be connectable to an external power source via an interface connector (not shown) provided through the body 110 (e.g., a D-sub, RJ45 or USB connector). The external power source can be a mains power source, or the gauge 100 can be connected to take power from the wider vacuum system (e.g., the vacuum pump) it is measuring the pressure of.

In another example, the gauge 100 may alternatively/additionally include an internal power source, such as a battery (not shown). The battery may be removable and replaceable from the body 110, it may also be a rechargeable battery, such as a Lithium ion battery.

The gauge 100 also includes an orientation sensor 160 (that is only schematically illustrated in FIG. 2) in electrical communication with the microcontroller 155.

The orientation sensor 160 is configured to output a data signal to the microcontroller 155 that is indicative of a particular orientation of the pressure sensing element 130. As will be discussed in more detail below, this allows the microcontroller 155 to account for the orientation of the pressure sensing element 130 when calculating the pressure output from the pressure sensing element 130.

Although the orientation sensor 160 is schematically illustrated as being included within the electronics module 150 of the gauge 100, within the scope of this disclosure, it is not be limited to such placement.

For example, it may be located at any other location in the gauge 100 where it can effectively recognise the relative orientation of the pressure sensing element 130 (i.e., differentiate between different orientations of the pressure sensing element 130) and communicate with the microcontroller 155.

In one such example, the orientation sensor 160 may be fixed to the pressure element 130. In another such example, the orientation sensor 160 may be fixed to or integrated into the body 110 of the gauge 100.

The orientation sensor 160 can be any sensor or combination of sensors that can provide signals indicative of different pressure sensing element orientations. For example, the orientation sensor 160 could be one of, or a combination of, an accelerometer, gyroscope, magnetometer and a tilt switch.

FIGS. 3A-3D show different possible orientations of the pressure sensing element 130 that have been found to cause variation in the pressure output from the gauge 100 (i.e., owing to convective effect at higher gauge pressures—100 mbar to 1,000 mbar).

In FIG. 3A, the pressure sensing element 130 is aligned vertically.

In FIG. 3B, the pressure sensing element 130 is aligned horizontally but the V-shaped filament is aligned in a vertical plane (i.e., is vertically in line with the support bar 136).

In FIG. 3C, the pressure sensing element 130 is aligned horizontally but the V-shaped filament is aligned in a horizontal plane facing down (i.e., positioned below the support bar 136 in the vertical direction).

In FIG. 3D, the pressure sensing element 130 is aligned horizontally but the V-shape of the filament is aligned in a horizontal plane facing up (i.e., positioned above the support bar 136 in the vertical direction).

Although not shown for clarity in FIGS. 3A-3D, it will be appreciated that in use, the pressure sensing element 130 will be provided with the rest of the gauge components (e.g., gauge body 110, end cap 118, electronics module 150 and sensor 160 etc.) around it as shown in FIGS. 1 and 2.

As the skilled person will understand, it may be desirable to position the vacuum gauge 100 and pressure sensing elements 130 at different orientations in order to accommodate different vacuum pump designs and spatial arrangements. Thus, a gauge 100 that can account for these (or more) different orientations is advantageous.

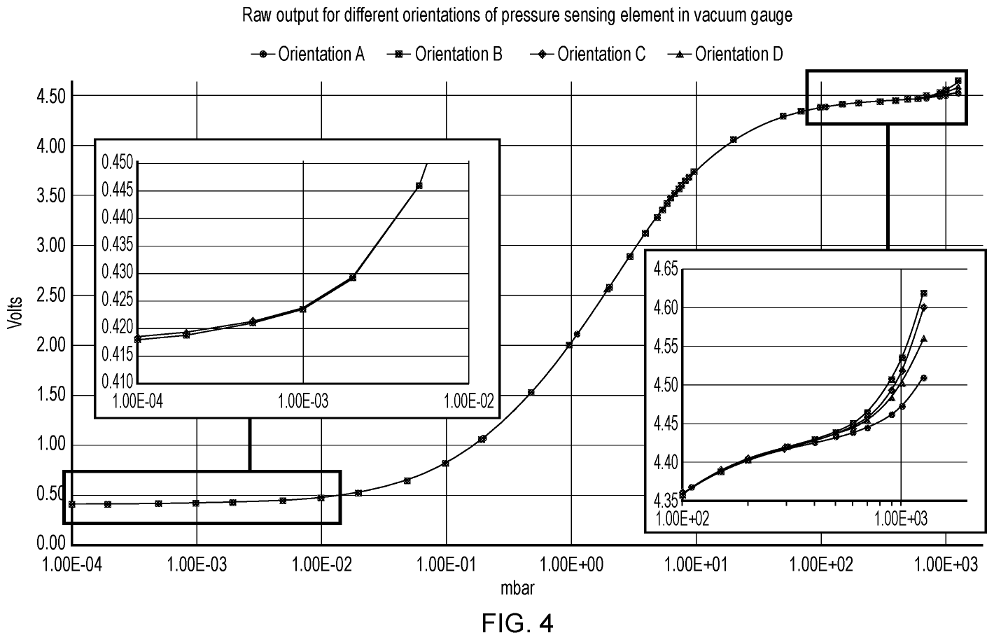

FIG. 4 is a graph that demonstrates a variation in gauge output that can be seen from the pressure sensing element 130 when it is used in the different orientations according to FIGS. 3A-3D. The graph is schematic and for illustration purposes only.

The lines of each gauge output are labelled A-D according to the respective orientation of the pressure sensing element 130 shown in FIGS. 3A-3D. In other words:
Orientation A=pressure sensing element 130 aligned vertically.
Orientation B=pressure sensing element 130 aligned horizontally in a vertical plane.
Orientation C=pressure sensing element 130 aligned horizontally in a horizontal plane facing down.
Orientation D=pressure sensing element 130 aligned horizontally in a horizontal plane facing up.

In the depicted example, the pressure sensing element 130 is a heating element operated to maintain a constant temperature.

Accordingly, the x-axis shows the pressure indicated from the vacuum gauge 100 and the y-axis shows the relative voltage that may maintain the heating element at the constant temperature for that pressure output value.

Although particular values of P are specified in mbar along the x-axis and particular values of V are specified in volts along the y-axis, these are just for one particular example gauge 100 that is used to provide a better understanding of the disclosure.

It is to be understood that within the scope of this disclosure the vacuum gauge 100 may operate to a higher or lower range of pressure output values and these may correlate with different voltage values than shown. Indeed, different gauge implementations, applications and control circuitry will provide different voltage vs pressure output value characteristics (e.g., due to having less/more inherent electrical resistance).

As shown in FIG. 4, for the majority of the operating range of the vacuum gauge 100 (i.e., 10⁻⁴ mbar to 10² mbar) the voltage applied and the corresponding pressure output values are substantially the same for the different pressure sensing element 130 orientations A-D. However, as highlighted in FIG. 4, at higher pressures moving towards atmospheric pressure (i.e., 10² mbar to 10³ mbar), the different orientations A-D can be seen to cause a variation in the voltages applied to the pressure sensing element 130 in order to provide the same pressure output value.

As discussed above, in the case of the thermal conductivity vacuum gauge 100, this variation is caused by convective effects due to the heating of the pressure sensing element 130. For example, it appears some orientations generate a greater convective effect than others, and so use a greater voltage to maintain the temperature of the pressure sensing element 130 for a particular output pressure value than other orientations.

For example, as shown in FIG. 4, it has been found that the voltage output for a given pressure value in orientation B is higher than that of orientation C, which is higher than that of orientation D, which is higher than that of orientation A.

Unlike the depicted examples, known gauges are not equipped with an orientation sensor 160 and a microcontroller 155 configured to account for the effects of pressure sensing element orientation on the gauge output data. Thus, known gauges are unable to determine the relative orientation of the pressure sensing element 130 and account for voltage and pressure output data variations due to different orientations of the pressure sensing element 130. In doing so, known gauges ignore the influence of the convective effect and its implications across different pressure sensing element 130 orientations. The depicted examples address this issue.

As will be appreciated by the skilled person, a known gauge 100 and microcontroller 155 is programmed to allow the gauge 100 to account for voltage vs pressure output value changes found in different examples of the same gauge design (e.g., due to minor manufacturing or compositional variations in the pressure sensing element 130/gauge 100, differing degrees of contamination on the pressure sensing element 130/gauge 100, and variations in the local environment (e.g., outside temperature)). To achieve this, it is generally known for the microcontroller 155 to be configured to normalise and apply a transfer function to the data received from the pressure sensing element 130 to provide corrected pressure output values that account for these variations.

In an exemplary normalisation process, the microcontroller 155 comprises a processor 156 and a memory 157 in communication therewith. The memory includes a lookup table of reference data values and instructions that cause the processor 156 to normalise the raw output data received from the pressure sensing element 130 according to a predetermined offset and span adjustment (e.g., in x and y-axis output values), and carry out a transfer function thereon according to a comparison with the reference data values. This process results in the microcontroller 155 shifting and remapping the raw output data values to provide a more consistent and accurate set of output values for the gauge.

This known normalisation process fails to account for gauge output value variations due to the aforementioned orientation-dependent convective effect at higher pressure values. Thus, the output data variation depending on orientation shown in FIG. 4 will provide deviations in the normalised output values that lead to inaccuracies and inconsistencies in the gauge output.

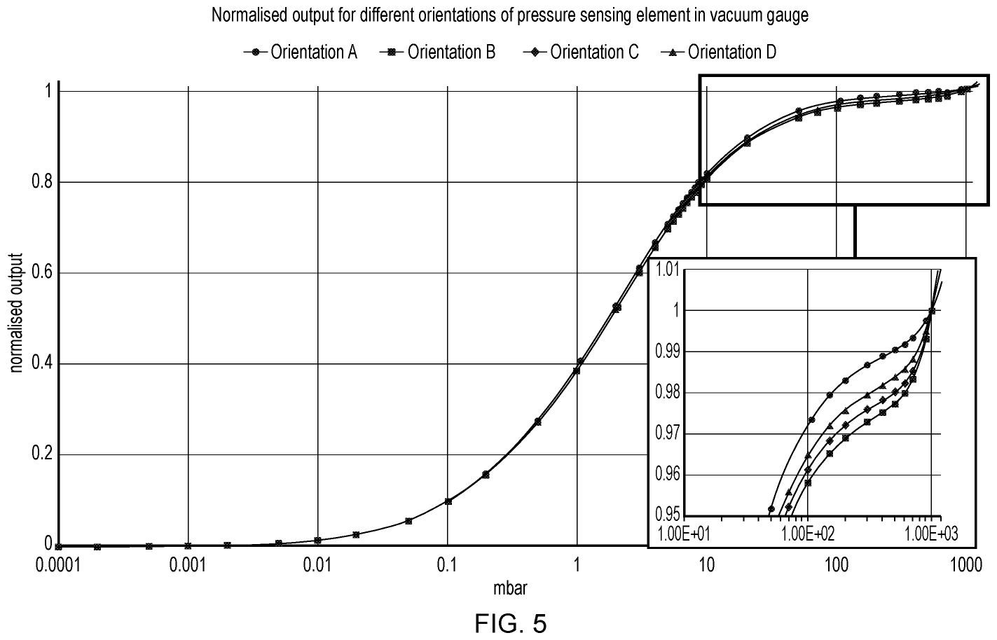

FIG. 5 shows the results of such a normalisation process being performed on the different output data results for orientations A-D from FIG. 4.

As shown in FIG. 5, not only does this result in significant variation in the normalized output values between the different orientations A-D at relatively higher pressures (˜10² to ˜10³ mbar) (where the convective effect is more significant), but it also adversely effects the normalised output values for each orientation A-D at lower pressures too (˜10⁻³ to ˜10² mbar) (albeit to a lesser extent). Therefore, there is also a need to account for the aforementioned orientation variations after the normalisation process.

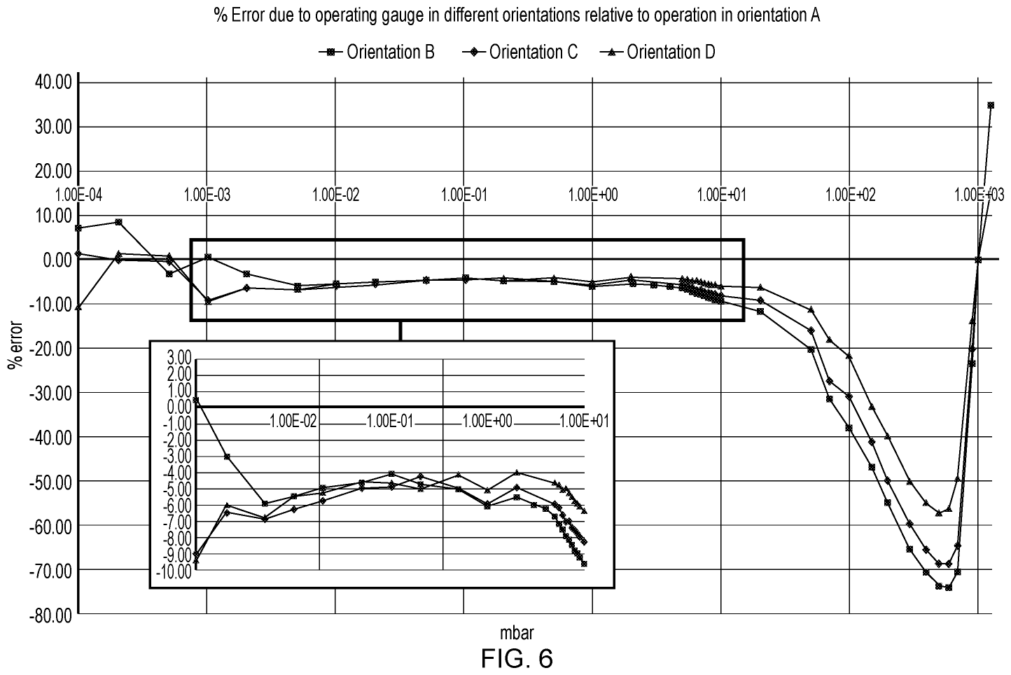

In FIG. 6, the output data for orientations B-D from FIG. 4 has been normalised according to reference data that was compiled for a pressure sensing element 130 having vertical orientation A. The percentage error for the resulting normalised pressure output values indicated by the gauge P_{indicated} compared to the true pressure Pₜᵣᵤₑ is shown.

The percentage error is calculated as follows:

$$\% error = 100 \times ( {P}_{indicated - {P}_{true}} ) / {P}_{true}$$

It will be seen that the output variation of the horizontal orientations B-D compared to the vertical orientation A results in approximately a −5% error in gauge pressure output values at lower operating pressures (˜10⁻³ to ˜10⁻² mbar) and increased—% errors at higher operating pressures (˜10¹ to ˜10³ mbar), peaking at between approximately −55% error to approximately −75% error (between 500-600 mbar) depending on the particular orientation B-D.

Accordingly, as will appreciated, if the user were to utilise such a gauge in a horizontal orientation (such as orientations B-D) instead of a vertical orientation (i.e., orientation A) these errors will result in inaccurate pressure readings for the gauge. As discussed above, users may use such different orientations of the pressure element 130 in order to conform to particular gauge application and spatial requirements.

In order to overcome this issue, the present disclosure utilises a correction factor CF that is applied to the normalised gauge output data when the orientation sensor 160 indicates that the gauge 100 is in an orientation that is different to that at which the reference data was taken, and for which the normalisation process was performed.

The correction factor CF is calculated before the gauge 100 is put into use according to the aforementioned percentage error, according to the equation below:

$$C F = 100 / ( \% error + 100 )$$

The calculated correction factor CF is stored in the memory of the microcontroller 155 and is applied to the normalised output data P_{indicated} by the microcontroller 155 when the orientation sensor 160 indicates this may be desirable.

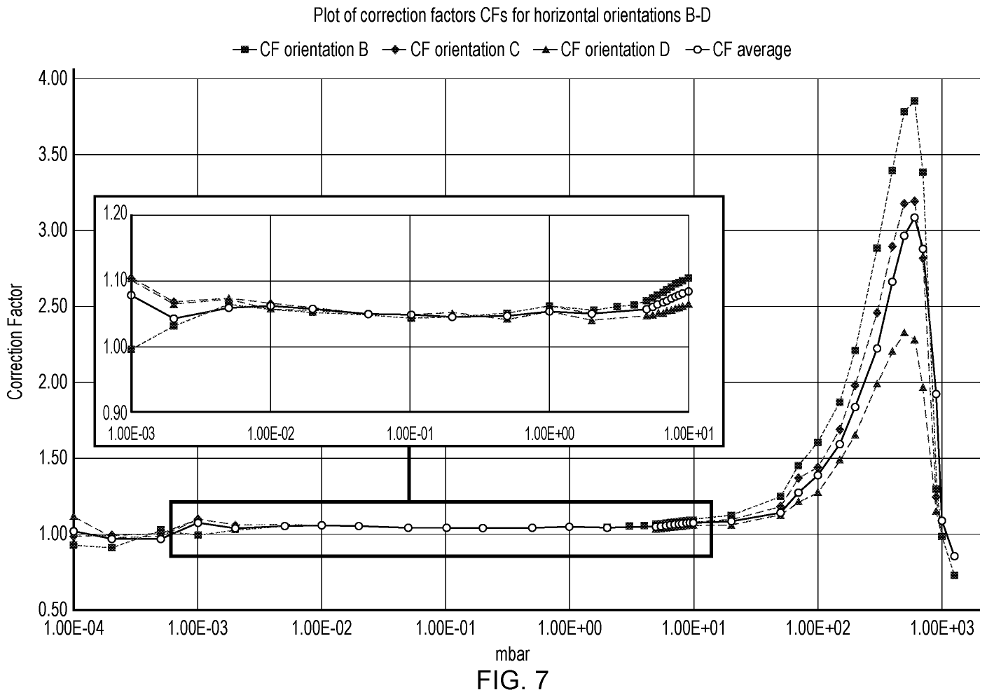

FIG. 7 shows an example of the correction factor CF calculated for each of the different horizontal orientations B-D in order to account for the different percentage errors occurring after the normalisation in FIG. 6.

As can be seen, the correction factor CF is relatively constant for the primary intended operating pressure ranges of the gauge assembly (˜10⁻³ to ˜10¹ mbar) where the percentage error between the horizontal orientations B-D and vertical orientation A is relatively constant. The correction factor CF becomes more substantial and varied at the higher pressure ranges (˜10¹ to ˜10³ mbar) where the convective effect and variations between orientations caused thereby are more prevalent.

In one example, as shown in FIG. 7, the normalisation and lookup reference data is calculated according to a vertical orientation A and a single average correction factor CF_{avg} is calculated corresponding to the average of the correction factors for each of the three different horizontal orientations B-D.

The correction factor CF is applied during use of the gauge 100 by the microcontroller 155 according to the general formula:

$${P}_{t r u e} = {P}_{indicated} \times C F$$

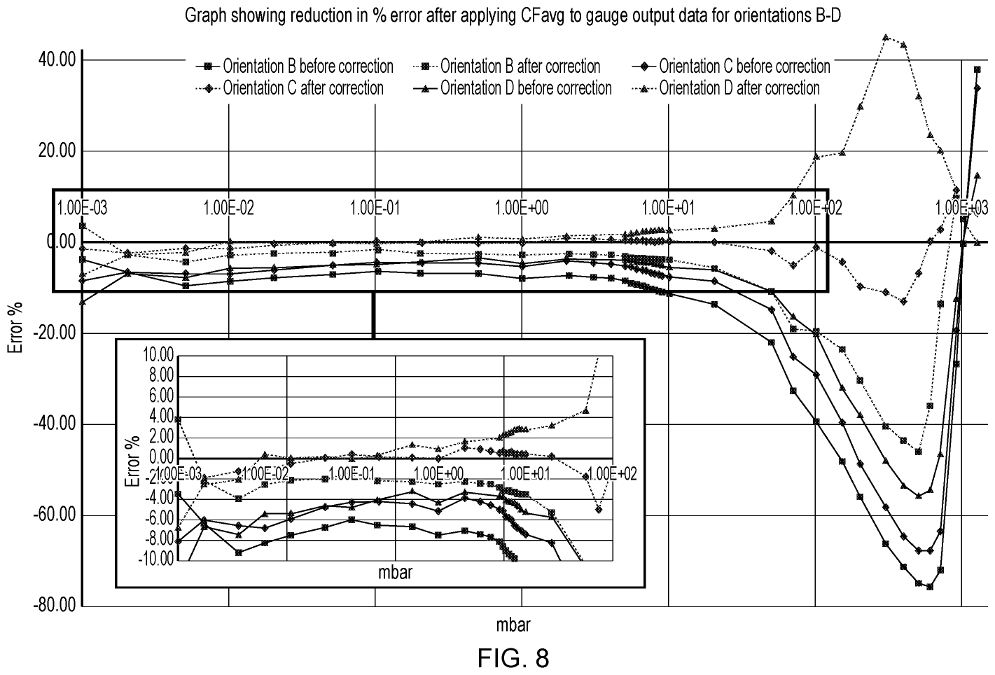

FIG. 8 shows the comparative reduction in percentage error that has been found when applying this average correction factor CF_{avg} to gauge output data for each of orientations B-D normalised according to orientation A.

As can be clearly seen in FIG. 8, by applying this correction factor CF_{avg} the percentage errors in the pressure output values are reduced across the operating range of the gauge 100, and particularly across the primary operating pressure range for the gauge assembly of ˜10⁻³ to ˜10¹ mbar.

Although some degree of error still exists, the result nevertheless provides a simple means to more accurately account for the convective effect variations on normalised gauge output. For example, only one correction factor may be calculated and stored before gauge use, and the orientation sensor 160 may only be able to differentiate between a vertical orientation and a general horizontal orientation in order for the correction factor to be correctly applied.

In another example, the orientation sensor 160 is configured to differentiate between the different horizontal orientations B-D, respectively, and the individual correction factor CF for each orientation B-D is stored by the microcontroller 155. The individual correction factor CF for each orientation B-D can then be applied to the normalised gauge output data by the microcontroller 155 when the particular orientation B-D is detected and indicated by the orientation sensor 160.

Although the present disclosure has been described with reference to vertical and horizontal orientations, it is to be appreciated that within the scope of this disclosure, correction factors CFs for any number of pressure sensing element 130 orientations (e.g., in between vertical and horizontal) could be calculated, stored and applied by the microcontroller 155 in the same way. This is of course provided the orientation sensor 160 is configured to effectively differentiate between each different orientation.

As will be appreciated, such examples may use a plurality of orientation sensors/more sophisticated orientation sensors, as well as the calculation, storage and application of more reference data and correction factors CFs than in the examples utilising a CF_{avg} as shown in FIGS. 8 and 9. However, they may provide a more ‘complete’ treatment of the errors from each individual orientation, and so can lead to further improved accuracy for the gauge output.

Furthermore, although the described examples apply the normalisation process according to reference data for a vertical orientation A, in other examples the normalisation process may be applied according to reference data for any other orientation (e.g., any of horizontal orientations B-D), and the percentage errors and correction factors calculated with reference thereto instead.

As mentioned above, it is to be understood that the present disclosure may also be applicable to other types of vacuum gauges (e.g., other than the Pirani or thermal conductivity vacuum gauges exemplified), where convective effects are not present/relevant, but whose output pressure values may nevertheless still be adversely affected by the orientation of the pressure sensing element therein.

It is to be appreciated that although the same normalisation processes and correction factors discussed above may not need to be applied in such alternative gauge applications, a suitable correction can nonetheless be calculated and applied to the gauge output values according to the orientation detected by the orientation sensor.

One such example (also mentioned above) is capacitance diaphragm vacuum gauges, where the indicated gauge pressure output values derived are dependent on the spacing between a diaphragm and a plate. Changes in gauge orientation can change the geometry of the diaphragm and in turn change the spacing without a corresponding change in pressure, thus producing inaccuracies in the pressure output value.

In applying the present disclosure to such an example, corrections to the pressure output value can be calculated and applied according to the changes in spacing found for particular orientations of the diaphragm. When the orientation sensor indicates a particular orientation, the appropriate correction can then be applied. The correction may thus take the form of a correcting offset to the indicated output values that is sized according to the amount of change in spacing known or expected for the particular orientation that is determined.

1. A vacuum gauge assembly for measuring gas pressure in a vacuum system, the assembly comprising:
a pressure sensing element;
an orientation sensor configured to determine an orientation of the pressure sensing element; and
a microcontroller configured to determine a gas pressure using data received from both the pressure sensing element and the orientation sensor.

2. The vacuum gauge assembly of claim 1, wherein the microcontroller is configured to use data received from the orientation sensor to determine a correction to be applied to the data received from the pressure sensing element and apply the correction to the data received from the pressure sensing element to determine the gas pressure.

3. The vacuum gauge assembly of claim 2, wherein the microcontroller is configured to normalise the data received from the pressure sensing element and apply the correction in the form of a correction factor to the normalised data.

4. The vacuum gauge assembly of claim 3, wherein the microcontroller comprises a memory and a processor in electrical communication therewith, wherein the memory stores a lookup table of reference data and the correction factor, and instructs the processor to normalise the data received from the pressure sensing element before applying a transfer function and the correction factor thereto.

5. The vacuum gauge assembly of claim 2, wherein the orientation sensor is configured to determine if the pressure sensing element is in one of a first orientation or a second orientation, and the microcontroller stores a correction factor according to the second orientation, and is configured to selectively apply the correction factor according to whether the first or second orientation is determined by the orientation sensor.

6. The vacuum gauge assembly of claim 5, wherein the first orientation corresponds to a vertical orientation of the pressure sensing element, and the second orientation corresponds to a horizontal orientation of the pressure sensing element or vice versa.

7. The vacuum gauge assembly of claim 5, wherein the correction factor is an average of a plurality of correction factors determined for different orientations of the pressure sensing element.

8. The vacuum gauge assembly of claim 5, wherein the orientation sensor is further configured to determine if the pressure sensing element is in one of a third or fourth orientation, and the microcontroller stores a first, second and third correction factor according to the second, third and fourth orientation, respectively, and is further configured to selectively apply the first, second or third correction factor according to the first, second, third or fourth orientation being determined by the orientation sensor, respectively.

9. The vacuum gauge assembly of claim 8, wherein the first orientation is a vertical orientation of the pressure sensing element and the second, third and fourth orientations are different horizontal orientations of the pressure sensing element.

10. The vacuum gauge assembly of claim 1, wherein the pressure sensing element is a heater element for a Pirani vacuum gauge.

11. A method of correcting a gas pressure output value in a vacuum gauge assembly, the method comprising:
receiving data from a pressure sensing element indicative of a gas pressure;
receiving data from an orientation sensor indicative of an orientation of the pressure sensing element;
determining a corrected gas pressure output value using the data received from both the pressure sensing element and the orientation sensor.

12. The method of claim 11, further comprising:
determining a correction to be applied to the data received from the pressure sensing element based on the data received from the orientation sensor; and
applying the correction to the data received from the pressure sensing element in response to the data received from the orientation sensor.

13. The method of claim 11, wherein the data received from the orientation sensor determines if the pressure sensing element is in one of a first orientation or a second orientation, and the method further comprises:
selectively applying the correction to the data received from the pressure sensing element based on whether the first or second orientation is determined by data from the orientation sensor.

14. The method of claim 11, further comprising:
normalising the data received from the pressure sensing element and applying a transfer function thereto using a lookup table of reference data before applying the correction; and
applying the correction in the form of a correction factor to the normalised data.

15. The method of any of claim 11, wherein the method is performed using a microcontroller.
